(19) United States
(12) Patent Application Publication
(10) Pub. No.: US 2004/0233816 A1
(43) Pub. Date: Nov. 25, 2004

(54) Method and apparatus for modulating data to be recorded on disc-type recording medium, and recording medium for recording programs for realizing the method

(75) Inventors: Kiu-hae Jung, Suwon-si (KR); Jae-seong Shim, Seoul (KR); Hyun-soo Park, Seoul (KR)

Correspondence Address: STAAS & HALSEY LLP, SUITE 700, 1201 NEW YORK AVENUE, N.W., WASHINGTON, DC, 20005, US

(73) Assignee: Samsung Electronics Co., Ltd., Suwon-si (KR)

(21) Appl. No.: 10/812,096

(22) Filed: Mar. 30, 2004

(30) Foreign Application Priority Data
May 20, 2003 (KR) 2003-32088

(51) Int. Cl. G11B 5/09

(52) U.S. Cl. 369/59.23

(57) ABSTRACT

A data modulation method and apparatus for recording data on a disc-type recording medium, a sync code insertion method and apparatus using the same, and a recording medium for recording programs executing the methods. The method, which inserts a sync code into data recorded on a disc-type recording medium, includes inserting the sync code into an input data stream, wherein the sync code includes one pattern breaking the maximum run and other patterns aligned before and after the one pattern, the length of the other patterns being the same as or larger than a value obtained by dividing the outermost circumference radius of the disc-type recording medium by the innermost circumference radius. The sync code insertion method uses a sync code pattern made in consideration of the radii of the innermost and outermost circumferences of a disc on which data is recorded. Accordingly, even if a disc radius decreases and a ratio of the innermost circumference radius to the outermost circumference radius increases, it is possible to precisely detect a sync signal from and easily generate a phase locked loop (PLL) clock at both the innermost and outermost circumferences.

### CROSS-REFERENCE TO RELATED APPLICATIONS

This application claims the benefit of Korean Patent Application No. 2003-32088, filed on May 20, 2003, in the Korean Intellectual Property Office, the disclosure of which is incorporated herein by reference.

### BACKGROUND OF THE INVENTION

1. Field of the Invention

The present invention relates to a data modulation method and apparatus allowing data to be recorded on a disc-type recording medium, a synchronization (sync) code insertion method and apparatus used for the data modulation method and apparatus, and a recording medium for recording programs utilizing the methods. More particularly, the present invention relates to a data modulation method for improving the rate of detecting a sync code inserted into data during data modulation, a sync code insertion method used in the data modulation method, and a recording medium for recording programs for executing the methods.

2. Description of the Related Art

In order to record data on an optical disc, the data is modulated in accordance with a particular modulation-coding rule, converted into nonreturn-to-zero-inverted (NRZI) data, and then recorded on the optical disc. To exactly reproduce the modulated data, it is required to insert a sync code per predetermined unit of the data, i.e., per frame unit, during a write operation and reproduce the data while synchronizing all of the elements of a reproducing apparatus, based on the inserted sync code. Such a data modulation method is disclosed in U.S. Pat. No. 6,496,541 published on Dec. 17, 2002.

As optical disc-type recording media are developed so as to improve their recording densities and minimize their sizes, their diameters become smaller. A reduction in the diameter of a disc increases the ratio of the radius of the outermost circumference to the radius of the innermost circumference from the center of the disc (hereinafter referred to as “the innermost and outermost circumference radii”). This phenomenon triggers a need for developing data modulation, allowing a phase locked loop (PLL) clock to be generated at both the innermost and outermost circumferences.

### SUMMARY OF THE INVENTION

The present invention provides a sync code insertion method and apparatus for precisely detecting a sync code from both the innermost and outermost circumferences by generating the sync code in consideration of the ratio of the circumference radii, and a recording medium for recording programs executing the method.

The present invention also provides a data modulation method and apparatus for precisely detecting a sync code from both the innermost and outermost circumferences by generating the sync code in consideration of the ratio of the circumference radii, and a recording medium for recording programs executing the method.

According to an aspect of the present invention, a method of inserting a sync code into data recorded on a disc-type recording medium is provided. The method comprises inserting the sync code into an input data stream, wherein the sync code includes one pattern breaking the maximum run and other patterns aligned before and after the one pattern, the length of the other patterns being the same as or larger than a value obtained by dividing the outermost circumference radius of the disc-type recording medium by the innermost circumference radius.

The run length of the one pattern is preferably longer by a value of 1T than a maximum run length specified in a predetermined modulation-coding rule.

According to an aspect of the present invention, the one pattern of the sync code is repeated at least twice.

According to an aspect of the present invention, patterns are 4T in length and have a plurality of different sync signal patterns, and the distance between adjacent different sync signal patterns is 2T or more.

According to an aspect of the present invention, patterns are 3T in length and have a plurality of different sync signal patterns.

According to another aspect of the present invention, a computer readable recording medium for recording a program that executes a sync code insertion method so as to record a sync code in data to be recorded on a disc-type recording medium is provided.

According to yet another aspect of the present invention, a method of modulating m-bit data into n-bit data to record the m-bit data on a disc-type recording medium is provided. The method comprises modulating an input data stream in accordance with a predetermined modulation rule, determining a sync code that is to be inserted per predetermined unit of the modulated data stream, inserting the determined sync code into the modulated data stream, and converting the data stream containing the sync code into nonreturn-to-zero-inverted (NRZI) data. The sync code is determined using a sync code table that stores sync codes containing one pattern breaking the maximum run and other patterns aligned before and after the one pattern, the lengths of the other patterns being the same as or larger than a value obtained by dividing the outermost circumference recording radius of the disc-type recording medium by the innermost circumference recording radius.

According to yet another aspect of the present invention, a computer readable recording medium for recording a program that executes a data modulation method of modulating m-bit data into n-bit data so as to record data on a disc-type recording medium is provided.

According to still another aspect of the present invention, an apparatus is provided for inserting a sync code into data recorded on a disc-type recording medium. The apparatus comprises a sync code inserter which inserts the sync code into an input data stream, wherein the sync code includes one pattern breaking the maximum run and other patterns aligned before and after the one pattern, the lengths of the other patterns being the same as or larger than a value obtained by dividing the outermost circumference radius of the disc-type recording medium by the innermost circumference radius.

According to still another aspect of the present invention, an apparatus is provided for modulating m-bit data into n-bit data to record the m-bit data on a disc-type recording medium. The apparatus comprises a modulation unit modulating an input data stream in accordance with a predetermined modulation rule, a sync code determiner determining a sync code that is to be inserted per predetermined unit of the modulated data stream, a sync code inserter inserting the determined sync code into the modulated data stream, and a converter converting the data stream containing the sync code into nonreturn-to-zero-inverted (NRZI) data. The sync code determiner further comprises a sync code table. The sync code is determined using the sync code table which stores sync codes containing one pattern breaking the maximum run and other patterns aligned before and after the one pattern, the lengths of the other patterns being the same as or larger than a value obtained by dividing the outermost circumference recording radius of the disc-type recording medium by the innermost circumference recording radius. One of the sync codes stored in the sync code table is selected as the sync code which is to be inserted into the modulated data stream.

According to still another aspect of the present invention, a computer readable recording medium is provided for recording a program executing a sync code insertion method that records a sync code in data recorded on a disc-type recording medium. The method comprises inserting a sync code into an input data stream, wherein the sync code includes one pattern breaking the maximum run and other patterns aligned before and after the one pattern. The length of the other patterns is the same as or larger than a value obtained by dividing the outermost circumference radius of a disc-type recording medium by the innermost circumference radius.

According to still another aspect of the present invention, a computer readable recording medium is provided for recording a program executing a data modulation method which modulates m-bit data into n-bit data to record the m-bit data on a disc-type recording medium, wherein the method comprises modulating an input data stream in accordance with a predetermined modulation rule, determining a sync code to be inserted per predetermined units of the modulated data stream, inserting the determined sync code into the modulated data stream, and converting the data stream containing the sync code into NRZI data. The sync code is determined using a sync code table that stores sync codes in which one pattern breaking the maximum run and other patterns is aligned before and after the one pattern, the lengths of the other patterns being the same as or larger than a value obtained by dividing the outermost circumference radius of the disc-type recording medium by the innermost circumference radius.

Additional aspects and/or advantages of the invention will be set forth in part in the description which follows and, in part, will be obvious from the description, or may be learned by practice of the invention.

### BRIEF DESCRIPTION OF THE DRAWINGS

These and/or other aspects and advantages of the invention will become apparent and more readily appreciated from the following description of the embodiments taken in conjunction with the accompanying drawings in which: FIGS. 1A and 1B illustrate a result of detecting a sync code from a disc, the innermost and outermost circumference radii of which are substantially 6 mm and 22.5 mm, where a 2T pattern is positioned before and after a 9T9T pattern, according to an aspect of the present invention;

FIGS. 2A and 2B illustrate a result of detecting a sync code from a disc, the radii of the innermost and outermost circumferences of which are substantially 6 mm and 22.5 mm, where a 4T pattern is positioned before and after a 9T9T pattern, according to an aspect of the present invention;

FIG. 3 is a block diagram illustrating a structure of a sync code insertion apparatus according to an aspect of the present invention;

FIG. 4 is a block diagram illustrating a data modulation apparatus using the sync code inserting apparatus of FIG. 3, according to an aspect of the present invention; and

FIG. 5 is a flowchart illustrating a data modulation method according to an aspect of the present invention.

### DETAILED DESCRIPTION OF THE PREFERRED EMBODIMENTS

Reference will now be made in detail to the embodiments of the present invention, examples of which are illustrated in the accompanying drawings, wherein like reference numerals refer to the like elements throughout. The embodiments are described below to explain the present invention by referring to the figures.

Data modulation is performed to change the format of data into a suitable recording format prior to recording the data on a disc-type recording medium such as a magnetic disc, an optical disc, and a magneto-optic disc. In general, a data modulation technique RLL (1,7) is adopted to record data on a magnetic disc or a magneto-optic disc. In the technique, the minimum and maximum inversion periods between parameters are set, for example, to 2T and 8T Hereinafter, data modulation according to an aspect of the present invention will be described using the example RLL (1,7).

When the ratio of the radii of the innermost and outermost circumferences increases due to a reduction in their diameters, frequency information undergoes interference on the longest T of a sync code and the lengths of adjacent patterns.

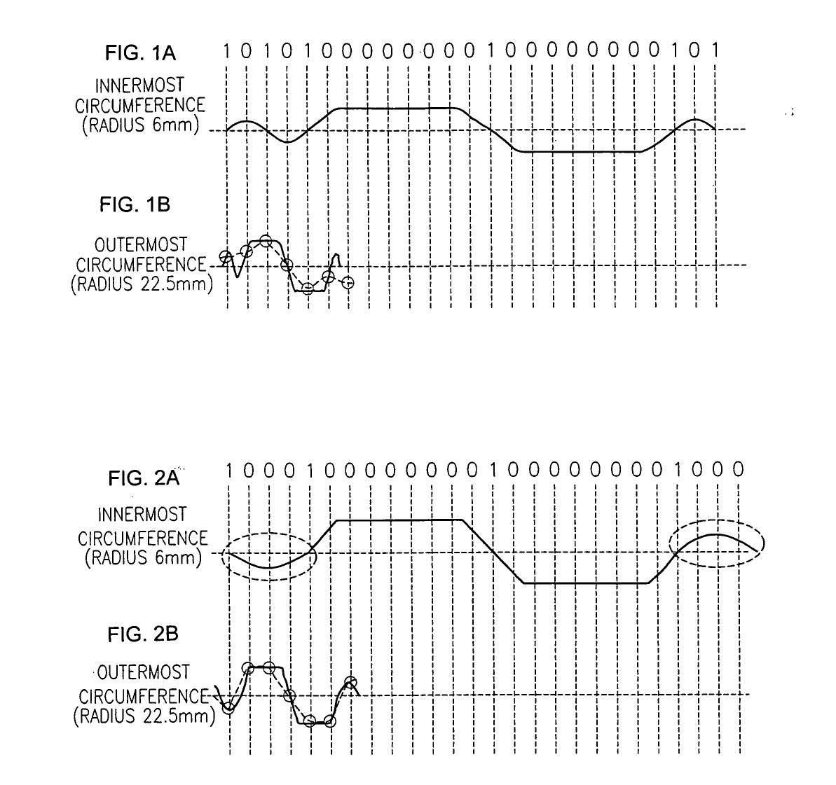

FIGS. 1A and 1B and 2A and 2B illustrate a precision of detecting frequency information at the longest T with respect to a disc, the radii of the innermost and outermost circumferences of which are substantially 6 mm and 22.5 mm, depending on the length of a pattern adjacent to a sync code.

FIG. 1A shows a sync detection result at the innermost circumference when 2T appear before and after a pattern having the form of 9T-9T FIG. 1B shows a sync detection result at the innermost circumference according to a clock rate when the 2T appear before and after the pattern of 9T-9T shown in FIG. 1A. FIG. 1B shows that the longest T pattern, i.e., 9T, is detected to be longer due to the appearance of the 2T pattern.

FIG. 2A shows a sync detection result at the innermost circumference when 4T appear before and after the pattern of 9T-9T shown in FIG. 1A. FIG. 2B shows a sync detection result at the innermost circumference according to a clock rate when 4T appear before and after the pattern of 9T-9T. FIG. 2B shows that frequency information regarding the longest T pattern, i.e., the pattern of 9T-9T, is appropriately expressed when 4T appear adjacent to the longest T pattern, i.e., the pattern adjacent to 9T. In other words, if the radius of the innermost circumference is 6 mm and the radius of the outermost circumference is 22.5 mm, a phase locked loop (PLL) clock is properly generated both at the innermost and outermost circumferences using a sync code where a pattern next to the longest T pattern is 4T.

The length of the pattern adjacent to the longest T pattern enabling proper generation of the PLL clock both at the innermost and outermost circumferences using the sync code is calculated as follows:

$$adjacent pattern length \geq \frac{outermost circumference length {R}_{max}}{innermost circumference length {R}_{min}} \qquad ( 1 )$$

It is possible to repeat the longest T pattern in the sync code several times so as to increase the rate of detecting the longest T pattern.

A method of generating a sync code on a disc, the recording radii of the innermost and outermost circumferences of which are 6 mm and 22.5 mm, according to an aspect of the present invention, will now be described.

| Data | Code |
|---|---|
| 11 | *0* |
| 10 | 001 |
| 01 | 010 |
| 0011 | 010 100 |
| 0010 | 010 000 |
| 0001 | 000 100 |
| 000011 | 000 100 100 |
| 000010 | 000 100 000 |
| 000001 | 010 100 100 |
| 000000 | 010 100 000 |
| 110111 (See Note 1). | 001 000 000 |
| 00001000 | 000 100 100 100 |
| 00000000 | 010 100 100 100 |

if XX1 then *0* = 000
XX0 then *0* = 101
# = 0: No termination case
# = 1: Termination case
Termination table

| | |
|---|---|
| 00 | 000 |
| 0000 | 010 100 |
| 110111 | 001 000 000 (next 010) |

Note 1
If the next channel bits are 010, 11 01 11 is converted into 001 000 000 after use of the main and termination tables.

In the conversion table shown in Table 1, the minimum run d is 1 and the maximum run k is 7.

The shorter the longest T in a sync code, the easier a PLL clock is generated. Therefore, the longest T in a sync code according to an aspect of the present invention is determined to be longer by 1T than the longest T generated in the conversion table shown in Table 1. That is, the longest T in the sync code is set to 9T

Also, since the radii of the innermost and outermost circumferences are substantially 6 mm and 22.5 mm, the length of the pattern adjacent to the longest T must be larger than 22.5 mm/6 mm, i.e., substantially 3.75, for precise generation of the PLL clock both at the innermost and outermost circumferences using the sync code, as expressed in Equation (1). According to an aspect of the present invention, the pattern adjacent to the longest T must be 4T or more. That is, since the minimum length of the pattern is 4T, the minimum length of the pattern is determined to be 21 bits in consideration of connection bits of a 2-bit code.

Accordingly, the sync code according to an aspect of the present invention is #01 000 100 000 000 100 010.

In the above sync code, # indicates cases where the termination table is used right before the sync code and where the termination is not used right before the sync code, according to the features of the conversion table of Table 1. For instance, if # is 1, the termination table is used, and if # is 0, the termination table is not used.

In general, when modulating a 4-bit or 1-byte (i.e., 8-bit) code, the sync code whose length is n times longer than the length of the modulated code is inserted. Also, when the sync code is inserted into data modulated in accordance with a modulation rule, the sync code is determined to meet both the run length rule for RLL coding and a Repeated Minimum Transition Ratio (RMTR) limiting condition, which is a feature of the conversion table shown in Table 1, for limiting repetitive appearance of the shortest T. Therefore, a 24-bit sync code is generated to obtain three different sync signal patterns shown in Table 2.

#01 000 100 000 000 100 010 001
#01 000 100 000 000 100 010 010
#01 000 100 000 000 100 010 100

According to an aspect of the present invention, if two of the three different sync signal patterns shown in Table 2 are required, #01 000 100 000 000 100 010 001 and #01 000 100 000 000 100 010 100 are selected, the distance between these sync signal patterns being 2 or more.

If at least three different sync signal patterns, which can be exactly detected, are required, the longest T in the sync signal is repeated twice and the length of the sync code is determined to be 36 bits.

#01 000 100 000 000 100 000 000 100 010 000 001
#01 000 100 000 000 100 000 000 100 010 000 100
#01 000 100 000 000 100 000 000 100 010 001 001
#01 000 100 000 000 100 000 000 100 010 010 000
#01 000 100 000 000 100 000 000 100 010 010 010
#01 000 100 000 000 100 000 000 100 010 100 001
#01 000 100 000 000 100 000 000 100 010 101 001

Referring to Table 4, a method of generating a sync code for a disc whose radii of the innermost and outermost circumferences are substantially 6 mm and 14 mm will now be described.

The longest T is set to 9T, which is only longer by 1T than the longest T generated in the conversion table shown in Table 1, since the shorter the length of the longest T in a sync code, the easier a PLL clock is to generate.

Also, if the radii of the innermost and outermost circumferences of a disc are substantially 6 mm and 14 mm, the length of a pattern adjacent to the longest T must be larger than a ratio, i.e., 14 mm/6 mm=2.33, of the outermost circumference to the innermost circumference, so as to exactly generate the PLL clock both at the innermost and outermost circumferences. That is, the length of an adjacent pattern is calculated to be 3T or more.

In the case where the length of the adjacent pattern is 3T or more, the longest T of the sync pattern is repeated twice, and the sync pattern is inserted into data modulated in accordance with the modulation rule, 30-bit sync signal patterns shown in Table 4 can be obtained by selecting a 30-bit code, which satisfies the run length rule.

#01 001 000 000 001 000 000 001 000 001
#01 001 000 000 001 000 000 001 000 010
#01 001 000 000 001 000 000 001 000 100
#01 001 000 000 001 000 000 001 000 101
#01 001 000 000 001 000 000 001 001 000
#01 001 000 000 001 000 000 001 001 001
#01 001 000 000 001 000 000 001 001 010

There is a probability that #01 001 000 00 001 000 000 001 000 101, which is one of the 30-bit sync signal patterns shown in Table 4, is affected by the following modulated data and does not satisfy the RMTR limiting condition, thus causing appearance of the shortest T seven times.

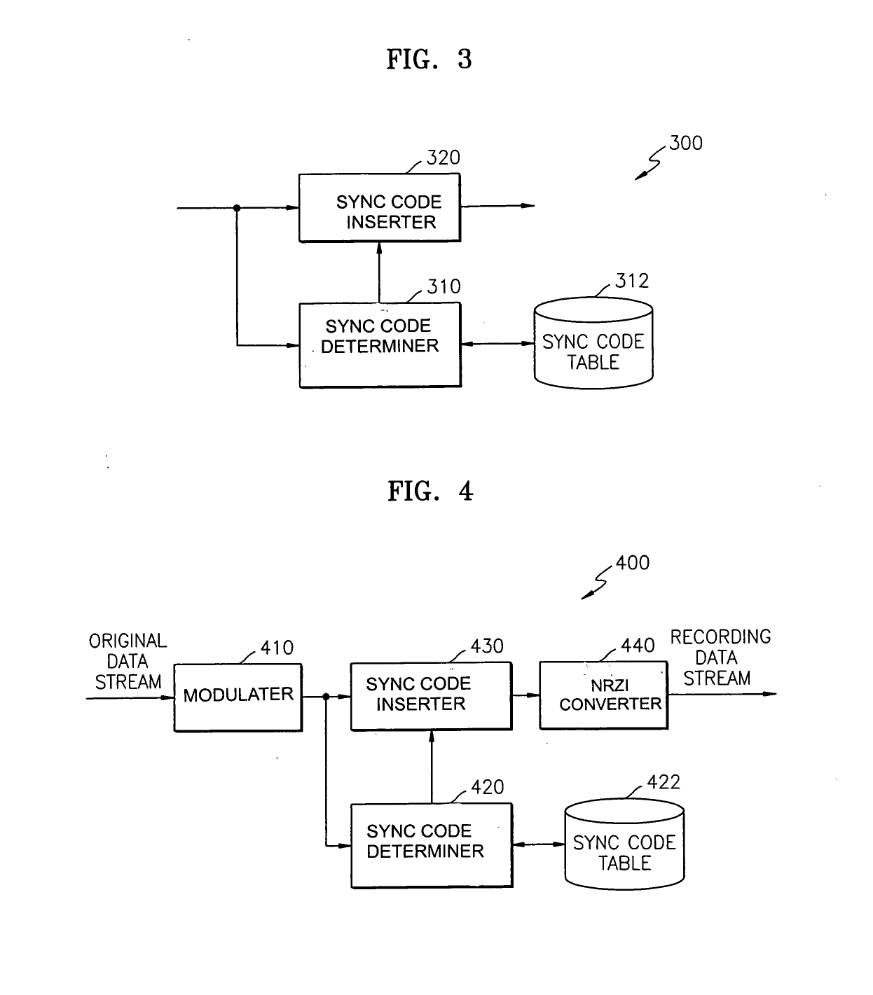

Hereinafter, a sync code insertion apparatus according to an aspect of the present invention will be described with reference to FIG. 3.

FIG. 3 illustrates a structure of a sync code insertion apparatus 300 capable of inserting a sync code per predetermined unit, e.g., a data stream, of data recorded on a disc-type recording medium according to an aspect of the present invention.

The sync code insertion apparatus 300 includes a sync code determiner 310, a sync code table 312, and a sync code inserter 320.

The sync code determiner 310 determines the pattern of a sync code inserted into data streams and transmits the determined pattern to the sync code inserter 320. The sync code determiner 310 sends the information regarding a sync code to the sync code inserter 320, the sync code being selected from the sync code table 312 based on a predetermined criterion.

The sync code table 312 stores a pattern exceeding the maximum run, and sync codes, in which patterns whose lengths are the same as or larger than a value obtained by dividing the outermost circumference radius Rₘₐₓ of a disc-type recording medium by the innermost circumference radius Rₘᵢₙ, are positioned before and after the pattern breaking the maximum run.

For instance, when the innermost circumference recording radius is substantially 6 mm and the outermost circumference recording radius is substantially 22.5 mm, the sync signal patterns shown in Table 2 or Table 3 are stored in the sync code table 312.

When the innermost circumference recording radius is substantially 6 mm and the outermost circumference recording radius is substantially 14 mm, the sync signal patterns shown in Table 4 are stored the sync code table 312.

The sync code inserter 320 inserts the sync code determined by the sync code determiner 310 into the input code stream and outputs the code stream containing the sync code.

FIG. 4 is a block diagram illustrating a structure of a modulation apparatus 400 using the sync code insertion apparatus 300 of FIG. 3, according to an aspect of the present invention. The modulation apparatus 400 includes a modulator 410, a sync code determiner 420, a sync code table 422, a sync code inserter 430, and a Nonreturn-to-Zero-Inverted (NRZI) converter 440.

The modulator 410 modulates an input data stream in accordance with a predetermined modulation rule to obtain a code stream and outputs the code stream to the sync code inserter 430. In this aspect of the present invention, the modulation rule adopted by the modulation unit 410 is one of Eight-to-Fourteen Modulation (EFM), EFMPlus, Run Length Limited (RLL) coding, and parity preserving coding.

The sync code determiner 420 determines the pattern of a sync code to be inserted into the data stream and transmits the determined pattern to the sync code inserter 430. Also, the sync code determiner 420 provides the sync code inserter 420 with the information regarding sync code, the sync code being selected from the sync code table 412 based on a predetermined criterion.

The sync code table 412 stores a pattern that breaks the maximum run, and sync codes, in which pattern whose lengths are the same as or larger than a value obtained by dividing the outermost circumference recording radius Rₘₐₓ of a disc-type recording medium by the innermost circumference recording radius Rₘᵢₙ, are positioned before and after the pattern.

For instance, if the innermost circumference recording radius Rₘᵢₙ is 6 mm and the outermost circumference recording radius Rₘₐₓ is 22.5 mm, the sync signal patterns shown in Table 2 or Table 3 are stored in the sync code table 412.

If the innermost circumference recording radius Rₘᵢₙ is 6 mm and the outermost circumference recording radius Rₘₐₓ is 14 mm, the sync signal patterns shown in Table 4 are stored in the sync code table 412.

The sync code inserter unit 430 inserts the sync code determined by the sync code determiner 430 into the code stream input from the modulation unit 410 and then provides the code stream containing the sync code to the NRZI converter 440.

The NRZI converter 440 converts the code stream into a recording code.

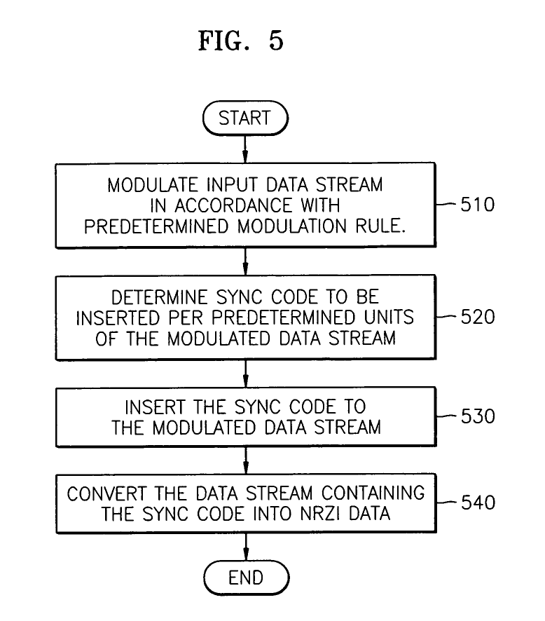

FIG. 5 is a flowchart illustrating a data modulation method performed by the data modulator 400 shown in FIG. 4, according to an aspect of the present invention.

Referring to FIG. 5, an input data stream is modulated in accordance with a predetermined modulation rule (operation 510).

Next, the pattern of a sync code to be inserted into the data stream is determined (operation 520). In this aspect of the present invention, the sync code is selected from the sync code patterns stored in the sync code table 412, based on a predetermined criterion. As previously mentioned, the sync code table 412 stores a pattern that breaks the maximum run, and sync codes, in which patterns whose lengths are the same as or larger than a value obtained by dividing the outermost circumference recording radius Rₘₐₓ of a disc-type recording medium by the innermost circumference recording radius Rₘᵢₙ, are positioned before and after the pattern breaking the maximum run.

After operation 520, the sync code determined in operation 520 is inserted into the modulated data stream (operation 530).

Next, the data stream into which the sync code inserted in operation 530 is converted into a recording code (operation 540).

An aspect of the present invention is embodied as a computer readable code in a computer-readable medium. Here, the computer-readable medium is any recording apparatus capable of storing data that is read by a computer system, e.g., a read-only memory (ROM), a random access memory (RAM), a compact disc (CD)-ROM, a magnetic tape, a floppy disk, an optical data storage device, and so on. Also, the computer-readable medium may be a carrier wave that transmits data via the Internet, for example. The computer-readable recording medium is distributed among computer systems that are interconnected through a network, and an aspect of the present invention is stored and implemented as a computer readable code in the distributed system.

As described above, a sync code insertion method and a data modulation method using the same, according to an aspect of the present invention, use a sync code pattern made in consideration of the radii of the innermost and outermost circumferences of a disc on which data can be recorded. Therefore, even if a reduction in the disc diameter reduces the ratio of the outermost circumference to the innermost circumference, it is possible to precisely detect a sync signal from and easily generate a PLL clock on both the innermost and outermost circumferences.

Although a few embodiments of the present invention have been shown and described, it would be appreciated by those skilled in the art that changes may be made in this embodiment without departing from the principles and spirit of the invention, the scope of which is defined in the claims and their equivalents.

What is claimed is:

1. A method of inserting a sync code into data recorded on a disc-type recording medium, the method comprising inserting the sync code into an input data stream,
wherein the sync code includes one pattern breaking the maximum run and other patterns aligned before and after the one pattern, the length of the other patterns being the same as or larger than a value obtained by dividing the outermost circumference radius of the disc-type recording medium by the innermost circumference radius.

2. The method of claim 1, wherein a run length of the one pattern is longer by 1T than a maximum run length specified in a predetermined modulation-coding rule.

3. The method of claim 1, further comprising repeating the one pattern of the sync code at least twice.

4. The method of claim 2, wherein the other patterns are 4T long and have a plurality of different sync signal patterns, and the distance between adjacent different sync signal patterns is 2 or more.

5. The method of claim 2, wherein the other patterns are 3T long and have a plurality of different sync signal patterns.

6. The method according to claim 1, wherein the innermost circumference radius is substantially 6 mm and the outermost circumference radius is substantially 22.5 mm.

7. The method according to claim 6, wherein either a 2T pattern or a 4T pattern is positioned before and after a 9T-9T pattern.

8. The method according to claim 4, wherein either the sync code has a first value and a termination table is used or the sync code has a second value and the termination table is not used.

9. A method of modulating m-bit data into n-bit data to record the m-bit data on a disc-type recording medium, the method comprising:
modulating an input data stream in accordance with a predetermined modulation rule;
determining a sync code to be inserted per predetermined unit of the modulated data stream;
inserting the determined sync code into the modulated data stream; and
converting the data stream containing the sync code into nonreturn-to-zero-inverted (NRZI) data,
wherein the sync code is determined using a sync code table that stores sync codes containing one pattern breaking the maximum run and other patterns aligned before and after the one pattern, the lengths of the other patterns being the same as or larger than a value obtained by dividing the outermost circumference recording radius of the disc-type recording medium by the innermost circumference recording radius.

10. The method of claim 9, wherein the length of the one pattern is longer by 1T than the maximum run length specified in a predetermined modulation-coding rule.

11. The method of claim 9, further comprising repeating the one pattern at least twice.

12. The method of claim 10, wherein the other patterns are 4T long and have a plurality of different sync code patterns, and the distance between adjacent different sync code patterns is 2 or more.

13. The method of claim 10, wherein the other patterns are 3T long and have a plurality of different sync code patterns.

14. The method according to claim 9, wherein when modulating a 4-bit or a 8-bit code, the inserting inserts a sync code whose length is n-times longer than a length of the modulated code.

15. The method according to claim 9, wherein upon the inserting the sync code into data modulated being in accordance with a modulation rule, the sync code is determined to meet both the run length rule for RLL coding and a Repeated Minimum Transition Ratio (RMTR) limiting condition to limit a repetitive appearance of a shortest T.

16. The method according to claim 12, wherein either the sync code has a first value and a termination table is used or the sync code has a second value and the termination table is not used.

17. The method according to claim 9, wherein the innermost circumference radius is substantially 6 mm and the outermost circumference radius is substantially 22.5 mm.

18. The method according to claim 17, wherein either a 2T pattern or a 4T pattern is positioned before and after a 9T-9T pattern.

19. An apparatus for inserting a sync code into data recorded on a disc-type recording medium, the apparatus comprising a sync code inserter which inserts the sync code into an input data stream,
wherein the sync code includes one pattern breaking the maximum run and other patterns aligned before and after the one pattern, the lengths of the other patterns being the same as or larger than a value obtained by dividing the outermost circumference radius of the disc-type recording medium by the innermost circumference radius.

20. The apparatus of claim 19, wherein the length of the one pattern is longer by 1T than the maximum run length specified in a predetermined modulation-coding rule.

21. The apparatus of claim 19, wherein the one pattern is repeated at least twice.

22. The apparatus of claim 20, wherein the other patterns are 4T long and have a plurality of different sync signal patterns, and the distance between adjacent sync signal patterns is 2 or more.

23. The apparatus according to claim 22, wherein either the sync code has a first value of 001 000 100 000 000 100 010 and a termination table is used or the sync code has a second value of 001 000 100 000 000 100 010 and the termination table is not used.

24. The apparatus of claim 20, wherein the other patterns are 3T long and have a plurality of different sync signal patterns.

25. An apparatus for modulating m-bit data into n-bit data to record the m-bit data on a disc-type recording medium, the apparatus comprising:
a modulator modulating an input data stream in accordance with a predetermined modulation rule;
a sync code determiner determining a sync code that is to be inserted per predetermined unit of the modulated data stream;
a sync code inserter inserting the determined sync code into the modulated data stream; and
a converter converting the data stream containing the sync code into nonreturn-to-zero-inverted (NRZI) data,
wherein the sync code determiner further comprises a sync code table, and the sync code is determined using a sync code table which stores sync codes containing one pattern breaking the maximum run and other patterns aligned before and after the one pattern, the lengths of the other patterns being the same as or larger than a value obtained by dividing the outermost circumference recording radius of the disc-type recording medium by the innermost circumference recording radius, and one of the sync codes stored in the sync code table is selected as the sync code which is to be inserted into the modulated data stream.

26. The apparatus of claim 25, wherein a length of the one pattern is longer by 1T than a maximum run length specified in a predetermined modulation-coding rule.

27. The apparatus of claim 25, wherein the pattern breaking the maximum run is repeated at least twice.

28. The apparatus of claim 26, wherein the other patterns are 4T long and have a plurality of different sync code patterns, and the distance between adjacent different sync code patterns is 2 or more.

29. The apparatus of claim 26, wherein the other patterns are 3T long and have a plurality of different sync code patterns.

30. A computer-readable recording medium for recording a program executing a sync code insertion method which records a sync code in data recorded on a disc-type recording medium, wherein the method comprises inserting a sync code into an input data stream,
wherein the sync code includes one pattern breaking the maximum run and other patterns aligned before and after the one pattern, the length of the other patterns being the same as or larger than a value obtained by dividing the outermost circumference radius of a disc-type recording medium by the innermost circumference radius.

31. The medium of claim 30, wherein the run length of the one pattern is longer by 1T than the maximum run length specified in a predetermined modulation-coding rule.

32. The medium of claim 29, wherein the one pattern is repeated at least twice.

33. A computer-readable recording medium for recording a program executing a data modulation method which modulates m-bit data into n-bit data to record the m-bit data on a disc-type recording medium, wherein the method comprises:
modulating an input data stream in accordance with a predetermined modulation rule;
determining a sync code to be inserted per predetermined units of the modulated data stream;
inserting the determined sync code into the modulated data stream; and
converting the data stream containing the sync code into NRZI data,
wherein the sync code is determined using a sync code table which stores sync codes in which one pattern breaking the maximum run and other patterns is aligned before and after the one pattern, the lengths of the other patterns being the same as or larger than a value obtained by dividing the outermost circumference radius of the disc-type recording medium by the innermost circumference radius.

34. The medium of claim 33, wherein a run length of the one pattern is longer by 1T than a maximum run length specified in a predetermined modulation-coding rule.

35. The medium of claim 32, wherein the one pattern is repeated at least twice.

36. A method of detecting a sync code from both an innermost circumference and an outermost circumference of a disc-type recording medium comprising generating the sync code in consideration of a ratio of the innermost circumference radius and the outermost circumference radius.

37. The method of detecting a sync code according to 36, wherein a length of a pattern adjacent to a longest T pattern is greater than or equal to the outermost circumference radius divided by the innermost circumference radius to enable proper generation of a phase locked loop (PLL) clock.

38. An apparatus for detecting a sync code from both an innermost and an outermost circumference, comprising:
a sync code determiner to determine a pattern of the sync code; and
a sync code inserter to insert the determined pattern of the sync code into a data stream,
wherein the sync code is generated in consideration of a ratio of the innermost circumference radius, and the outermost circumference radius.

39. The apparatus according to claim 38, wherein a length of a pattern adjacent to a longest T pattern is greater than or equal to the outermost circumference radius divided by the innermost circumference radius to enable proper generation of a phase locked loop (PLL) clock.
